(19) United States
(12) Patent Application Publication
(10) Pub. No.: US 2010/0224106 A1
(43) Pub. Date: Sep. 9, 2010

(54) TABLE WITH FOLDABLE LEGS

(75) Inventor: Darren ALDRED, Morristown, TN (US)

Correspondence Address: MCGUIREWOODS, LLP, 1750 TYSONS BLVD, SUITE 1800, MCLEAN, VA, 22102, US

(73) Assignee: Meco Corporation, Greeneville, TN (US)

(21) Appl. No.: 12/718,687

(22) Filed: Mar. 5, 2010

Related U.S. Application Data
(60) Provisional application No. 61/157,664, filed on Mar. 5, 2009.

(51) Int. Cl. A47B 3/08; F16M 11/16; A47B 13/02

(52) U.S. Cl. 108/115; 248/188.6; 403/325

(57) ABSTRACT

A table includes a main panel, side panels extending along the edges of the main panel, respectively, and including first and second side panels connected to each other at a corner of the main panel, the first pivot bar extending between inner surfaces of the first and second side panels near the corner of the main panel, a leg connected to the first pivot bar and configured to pivotally move between an unfolded position and a folded position with respect to the first pivot bar, and a locking unit configured to selectively engage the leg to prevent the leg from departing from the unfolded position.

### CROSS REFERENCE TO PRIOR APPLICATION

This application claims a priority and benefit thereof from U.S. Provisional Application No. 61/157,664 filed on Mar. 5, 2009, which is hereby incorporated by reference for all purposes as if fully set forth herein.

### BACKGROUND OF THE DISCLOSURE

1. Field of the Disclosure This disclosure is directed to a table, and more particularly to a table with foldable legs that are lockable in an unfolded position.

2. Related Art

A folding table is configured to be folded into a compact configuration and stored, for example, in a stack. Folding tables are frequently used for temporary situations such as parties, ceremonies and the like. To be portable and storable, folding tables are typically made of hard plastic, metal and/or wood with pivots to allow folding of the legs. The conventional folding tables, however, suffer from one or more drawbacks, such as being trouble-prone, unreliable in use and visually unattractive.

Particularly, in order to make it easier for the users to fold, unfold, transport and store the tables, the folding mechanism, such as, e.g., a lever, pivot, lock, spring and/or the like, for the tables is typically exposed externally. This may cause safety problems because the folding mechanism may be accidentally actuated by those who are not familiar with the folding mechanism, such as, e.g., children, thereby raising a safety concern.

### SUMMARY OF THE DISCLOSURE

In one aspect of the disclosure, a table includes a main panel, side panels extending along the edges of the main panel, respectively, and including the first and second side panels connected to each other at a corner of the main panel, the first pivot bar extending between inner surfaces of the first and second side panels near the corner of the main panel, a leg connected to the first pivot bar and configured to pivotally move between an unfolded position and a folded position with respect to the first pivot bar, and a locking unit configured to selectively engage the leg to prevent the leg from departing from the unfolded position.

The main panel and the first and second side panels may cover the first pivot bar and the locking unit to prevent the first pivot bar and the locking unit from being seen by a by-stander. The first and second side panels may be configured to prevent the leg from pivotally moving outwardly from the unfolded position.

The leg may include an opening formed at the upper end portion of the leg and extending from an outer surface to an inner surface of the leg, and a locking bar located on the inner surface of the leg adjacent to a bottom end of the opening.

The locking unit may include the second pivot bar extending between inner surfaces of the first and second side panels near the corner of the main panel, a latch pivotally connected to the second pivot bar and extending through the opening of the leg to selectively engage the locking bar to prevent the leg from pivotally moving from the unfolded position, and a spring connected to the latch to bias the latch towards the locking bar of the leg. The second pivot bar may be located between the first pivot bar and the corner of the table. The spring may be extending from the first pivot bar to the latch via the opening of the leg.

The latch may include the first end portion pivotally connected to the second pivot bar and connected to the spring, a body portion extending through the opening of the leg and having the first cutout configured to engage the locking bar of the leg, the second end including a lever protruding inwardly from the inner surface of the leg. The first cutout portion may be disengaged from the locking bar of the leg when a force is applied to move the lever upwardly. The body portion of the latch may further have the second cutout to prevent the latch from contacting the first pivot bar when the leg is in the folded position. The body portion of the latch may be bent upwardly near the lever.

In another aspect of the disclosure, a folding mechanism for a foldable table includes a pivot block connected to a main panel of the foldable table, the first pivot bar connected to the pivot block and a leg of the foldable table to allow the leg to pivotally move between an unfolded position and a folded position, the second pivot bar connected to the pivot block, and a latch pivotally connected to the second pivot bar and configured to selectively engage the leg to lock the leg in the unfolded position.

The pivot block may be located on a bottom surface of the main panel. The pivot block may be configured to prevent the leg from pivotally moving outwardly from the unfolded position.

The leg of the foldable table may include an opening formed at the upper end portion of the leg and extending from an outer surface to an inner surface of the leg, and a locking bar located on the inner surface of the leg adjacent to a bottom end of the opening. The latch may extend through the opening of the leg to selectively engage the locking bar of the leg.

The folding mechanism may further include a spring connected to the latch to urge the latch toward the locking bar of the leg. The spring may be extending from the first pivot bar to the latch via the opening of the leg.

The latch may include the first end portion pivotally connected to the second pivot bar and connected to the spring, a body portion extending through the opening of the leg and having the first cutout configured to engage the locking bar of the leg, the second end including a lever protruding inwardly from the inner surface of the leg. The first cutout portion may be disengaged from the locking bar of the leg when a force is applied to move the lever upwardly. The body portion of the latch may further have the second cutout to prevent the latch from contacting the first pivot bar when the leg is in the folded position. The body portion of the latch may be bent upwardly near the lever.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a perspective view of a table with foldable legs, constructed according to the principles of the disclosure;

FIG. 2 shows a partial enlarged view of a corner of the table shown in FIG. 1;

FIG. 3 shows a perspective view of a folding and locking mechanism of the table shown in FIG. 1, constructed according to the principles of the disclosure;

FIG. 4 shows a bottom view of the folding and locking mechanism shown in FIG. 3;

FIG. 5 shows a partial side cut view of the folding and locking mechanism shown in FIG. 3;

FIG. 6 shows a partial enlarged view of FIG. 5;

FIGS. 7A, 7B, 7C, 7D and 7E sequentially show the leg of the table shown in FIG. 1 in various degrees of folding according to the principles of the disclosure;

FIG. 8 shows a bottom view of the table shown in FIG. 1 with the legs completely folded;

FIG. 9 shows a side view of the table shown in FIG. 8;

FIG. 10A shows a bottom view of another table with foldable legs constructed according to the principles of the disclosure; and

FIG. 10B shows a bottom view of another table with foldable legs constructed according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

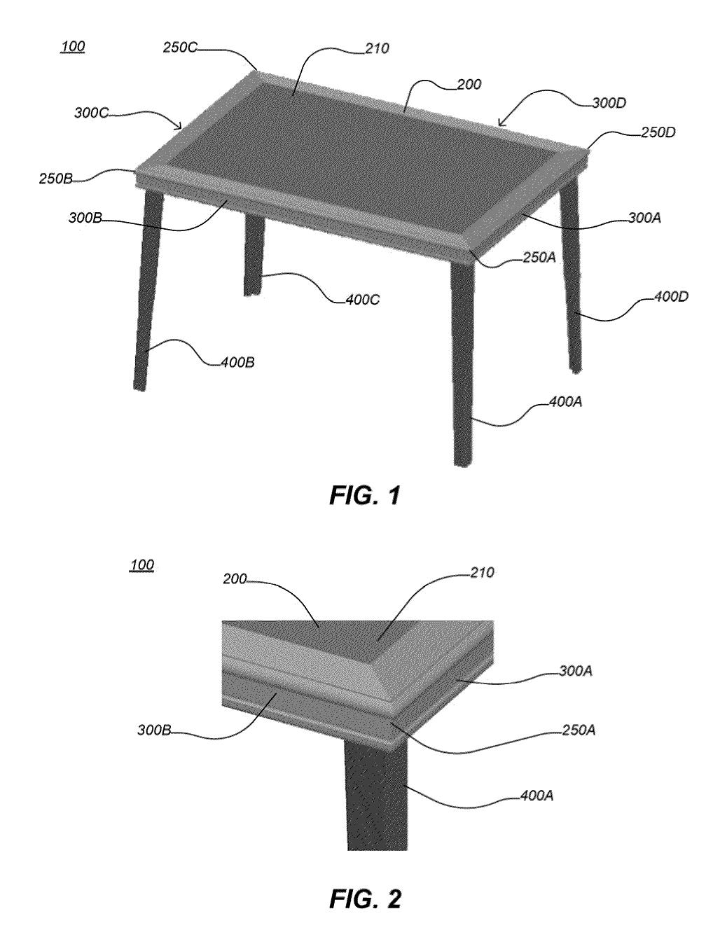

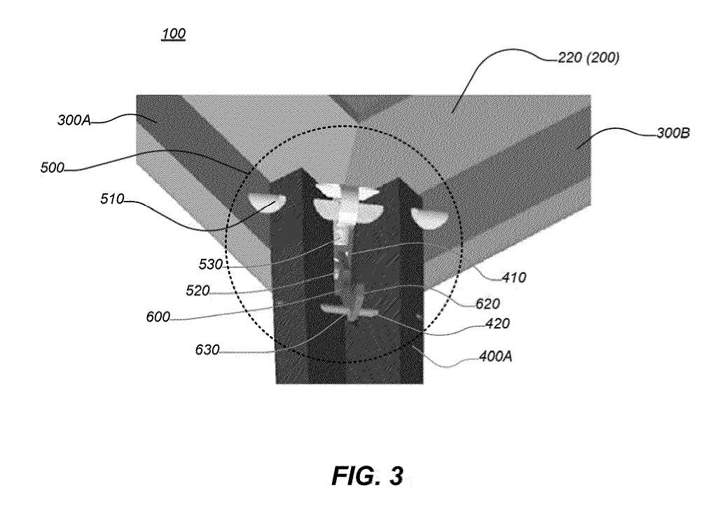

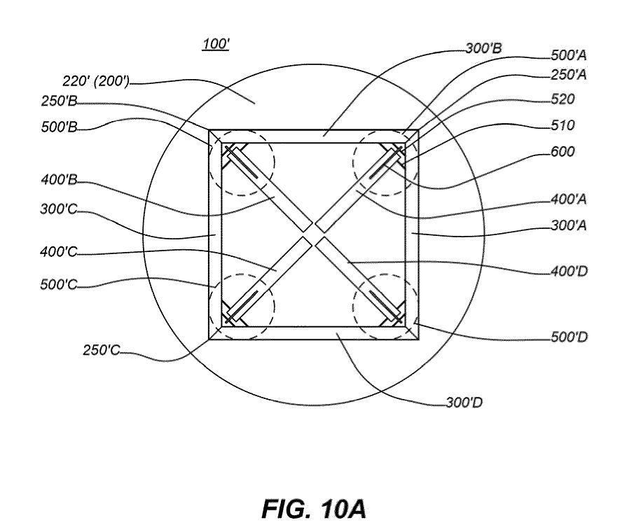

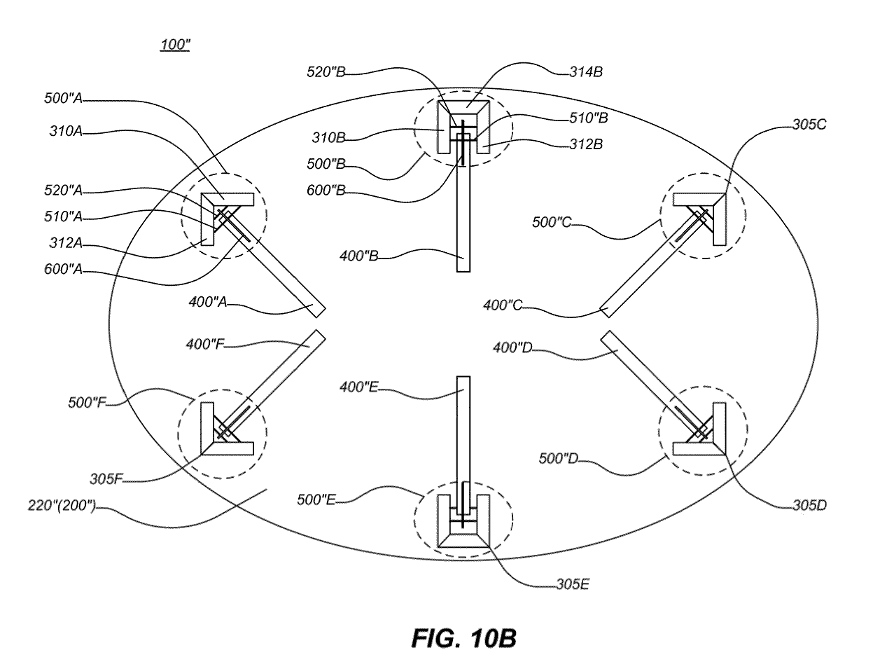

FIG. 1 shows a perspective view of a foldable table 100 constructed according to the principles of the disclosure. The table 100 may include a main panel 200, a number of side panels 300, a number of foldable legs 400 and/or the like. The main panel 200 has a rectangular shape with four corners 250A, 250B, 250C, 250D. The table 100 may have four side panels 300A, 300B, 300C, 300D and four foldable legs 400A, 400B, 400C, 400D. The side panels 300 may extend along edges of the main panel 200, respectively. The side panels 300 may be adjoining to each other at the corners 250 of the main panel 200. The side panels 300 may protrude downwardly from a bottom surface of the main panel 200 (also shown in FIG. 3). However, the configuration (e.g., shape and/or size) of the main panel 200 and/or the number and locations of the corners 250, the side panels 300 and/or the foldable legs 400 may vary. For example, the main panel 200 may have a different shape, such as, e.g., a square, circular (shown in FIG. 10A), elliptical shape (shown in FIG. 10B) or the like and may include no corners and/or side panels as shown in FIGS. 10A and 10B.

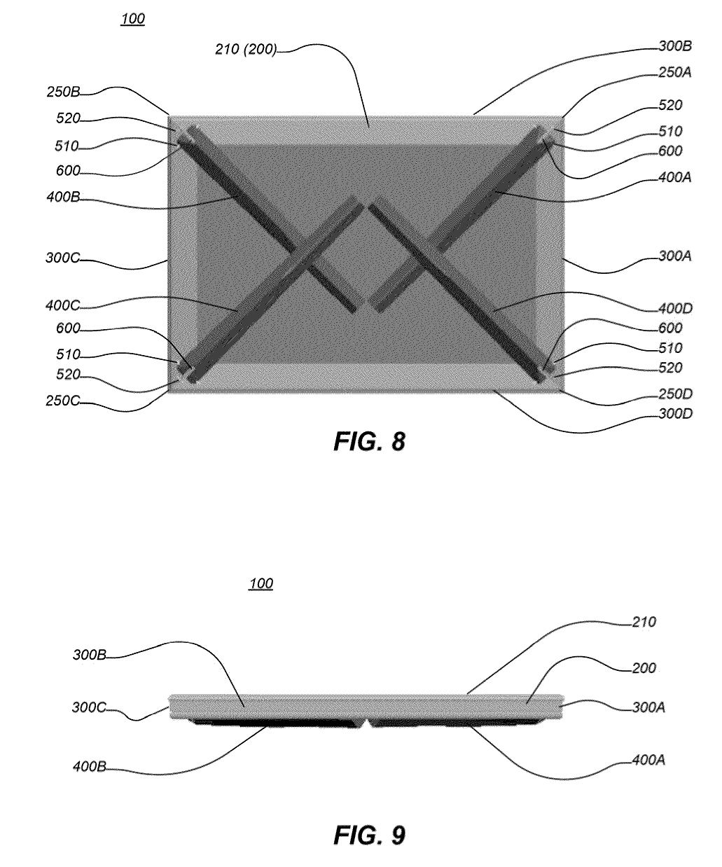

The table 100 may be constructed such that at least one of the legs 400 may pivotally move between an unfolded position and a folded position. The legs 400 may support the main panel 200 in the unfolded position as shown in FIG. 1. The legs 400 in the folded position may be positioned on a bottom surface 210 of the main panel 200 as shown in FIGS. 8 and 9 for easier transportation and storage. The legs 400 may be locked in the unfolded position. However, upon being unlocked, the legs 400 may be folded inwardly toward the bottom surface 210 of the main panel 200 (Shown in FIGS. 8 and 9). As shown in FIG. 2, which shows a partial enlarged view of a portion of the table 100 around the corner 250A shown in FIG. 1, a mechanism for folding and locking the legs 400 may be completely hidden under the main panel 200 and the side panels 300 and may not be seen by a by-stander.

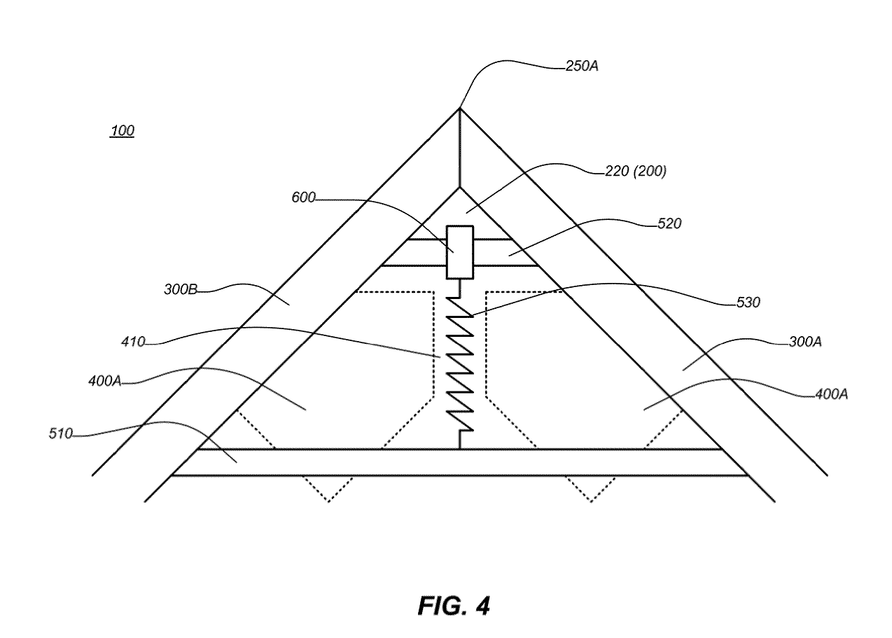

FIG. 3 shows a perspective view of a folding and locking mechanism 500 for the leg 400A shown in FIG. 1, constructed according to the principles of the disclosure. FIG. 4 shows a bottom view of the folding and locking mechanism 500 shown in FIG. 3. Referring to FIGS. 3 and 4 concurrently, the folding and locking mechanism 500 may include a leg pivot bar 510, a latch pivot bar 520, an opening 410, a latch locking bar 420, a spring 530, a latch 600, and/or the like. The opening 410 and the latch locking bar 420 may be formed at the leg 400A.

The leg pivot bar 510 may diagonally extend between inner surfaces of two adjoining side panels 300A, 300B in order to allow the leg 400A to pivot with respect thereto. The side panels 300A, 300B and the leg 400A may be constructed such that the leg 400A may not be allowed to rotate outwardly by the inner surfaces of the side panels 300A, 300B. The latch pivot bar 520 also may extend diagonally between the inner surfaces of the two adjoining side panels 300A, 300B to allow the latch 600 to pivot with respect thereto. A different construction may be used to pivot the leg 400A and the latch 600. For example, the leg pivot bar 510 and the latch pivot bar 520 may be directly attached to the bottom surface 220 of the main panel 200. Further, a pivot block (shown in FIG. 10B) may be attached to the bottom surface 220 of the main panel 200 to hold the leg pivot bar 510 and/or the latch pivot bar 520.

The opening 410 may be extending downwardly from an upper end portion of the leg 400A. The opening 410 may extend from an outer surface to an inner surface of the leg 400. The latch locking bar 420 may be located near a lower end of the opening 410. The latch 600 may be pivotally connected to the latch locking bar 420 at one end thereof and extend from one side of the leg 400 to another through the opening 410. The spring 530 may be connected to the latch pivot bar 520 to bias the latch 600 towards the latch locking bar 420. The spring 530 may extend from the leg pivot bar 510 through the opening 410 and connected to the end portion of the latch 600 connected to the latch pivot bar 520. Alternatively, the spring 530 may be connected to other locations, e.g., the bottom surface 220 of the main panel 200 or the like, and extend through the opening 410 to reach the latch 600.

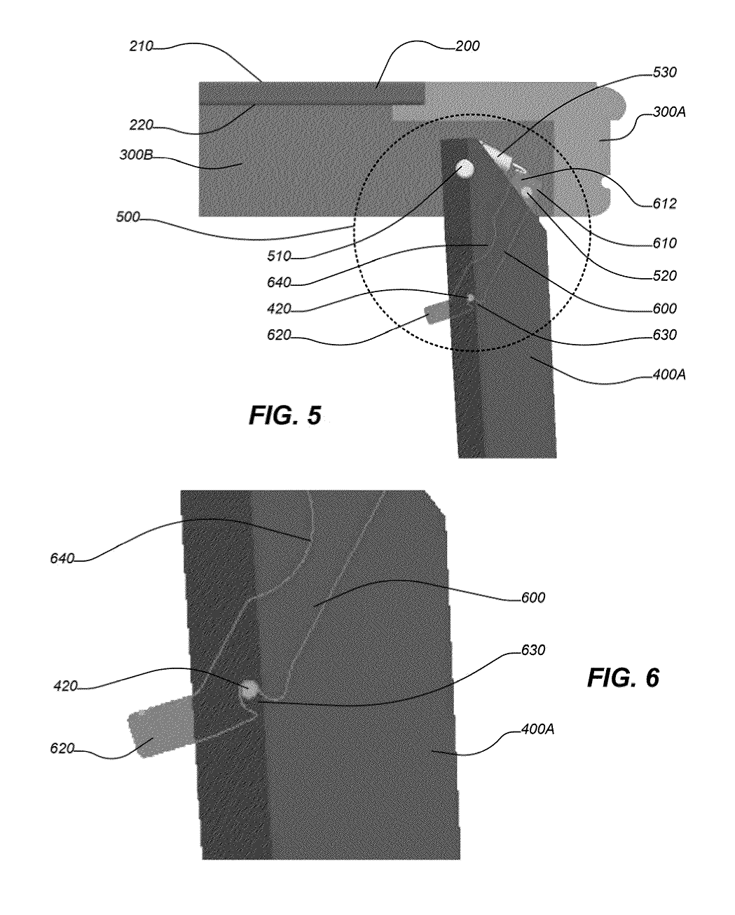

FIG. 5 shows a partial enlarged side cut view of the table 100 shown in FIGS. 3 and 4. FIG. 6 shows a partial enlarged view of FIG. 5. Referring to FIGS. 5 and 6 concurrently, the latch 600 may be a narrow plate with a slightly extended portion near one end thereof as shown in FIG. 6. More specifically, the latch 600 may have a top end portion 610, a bottom end portion 620, cutouts 630, 640 and/or the like. The top end portion 610 may be pivotally connected to the latch pivot bar 520, as mentioned above.

As noted above, the top end portion 610 of the latch 600 may engage an end of the spring 530. For example, a hole 612 may be formed at the top end portion 610 of the latch 600 and one end of the spring 530 may engage the hole 612. The other end of the spring 530 may be attached to the leg pivot bar 510 or a similar structure, as noted above. With this construction, the top end portion 610 of the latch 600 may be pulled inwardly towards the latch pivot bar 510 while the bottom end portion 620 may be urged outwardly. The bottom end portion 620 of the latch 600 may extend inwardly to function as a lever. For example, the leg 400A may be unlocked from the unfolded position when a force is applied to move the bottom end portion 620 upwardly, which is explained below in detail.

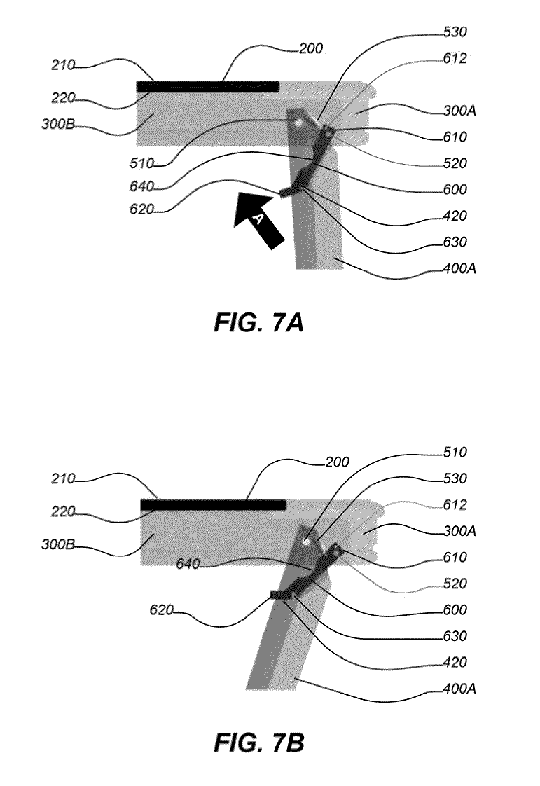

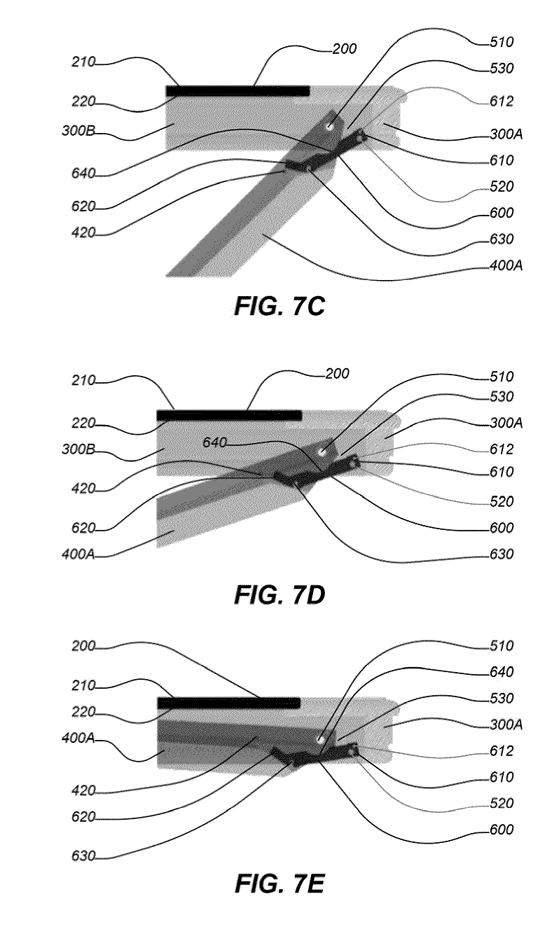

The cutout 630 may be located near the bottom end portion 620 in order to engage the latch locking bar 420 of the leg 400A. Once the latch locking bar 420 is inserted into the cutout 630, the cutout 630 may block the latch locking bar 420 from moving inwardly, thereby locking the leg 400A in the unfolded position. The latch 600 may be disengaged from the leg lock bar 420 when a force is applied to the bottom end portion 620 upwardly, and the leg 400A may be unlocked from the unfolded position. The additional cutout 640 may be formed on an opposite side of the cutout 630 to provide clearance between the latch 600 and the leg pivot bar 510 and/or other structures when the leg 400A is in the folded position, as shown in FIG. 7E.

FIGS. 7A, 7B, 7C, 7D and 7E sequentially show the leg 400A of the table 100 in various degrees of folding according to the principles of the disclosure. FIG. 7A shows the leg 400A locked in the unfolded position, in which the latch locking bar 420 of the leg 400A may engage the cutout 630 of the latch 600. The leg 400A may be unlocked by lifting the bottom end portion 620 of the latch 600 in a direction shown by arrow A. Once the leg 400A is unlocked, as shown in FIGS. 7B and 7C, the leg 400A may rotate inwardly towards the bottom surface 220 of the main panel 200. During the folding, the bottom end portion 620 of the latch 600 may be pushed upwardly by the latch locking bar 420, thereby slightly stretching the spring 530. This may slightly impede the rotational movement of the leg 400A, thereby preventing the leg 400A from quickly collapsing on and damaging the bottom surface 220 of the main panel 200. As shown in FIG. 7D, as the leg 400A approaches the bottom surface 220 of the main panel 200, the latch locking bar 420 may be completely separated from the latch 600 and the latch 600 may no longer be pushed by the latch locking bar 420. FIG. 7E shows the leg 400A in the folded position. The opening 410 of the leg 400A may be configured such that the latch 600 stays within the opening 410 and does not slip through the opening 410 and swing loosely.

FIG. 8 shows a bottom view of the table 100 shown in FIG. 1 with the legs 400 in the folded position, and FIG. 9 shows a side view of the table 100 shown in FIG. 8. As shown in FIG. 8, the legs 400 may be folded in diagonal directions with respect to the edges of the table 100. However, other orientations of the leg pivot bars 510 are contemplated, in such cases, the legs 400 may be folded in different directions. For example, the legs 400 may be folded parallel to two longer sides and/or two shorter sides of the table 100.

As noted above, the main panel 200 of the table 100 may have a different shape, such as, e.g., a square, circular, elliptical shape or the like. Further, the table 100 may be configured without the side panels 300. For example, FIG. 10A shows a bottom view of another foldable table 100′ constructed according to the principles of the disclosure.

As noted above, the foldable tables 100′ may include a main panel 200′ having a substantially circular shape. Further, the foldable table 100′ may have a plurality of horizontal bars 300′ located away from the edge of the circular main panel 200′. For example, the foldable table 100′ may include four horizontal bars 300′A, 300′B, 300′C, 300D′ adjoining each other to form four corners 250′A, 250′B, 250′C, 250′D. Four folding and locking mechanisms 500′A, 500′B, 500′C, 500′D may be arranged at the four corners 250′A, 250′B, 250′C, 250′D, respectively, to pivotally connect the four legs 400′A, 400′B, 400′C, 400′D, respectively, to the horizontal bars 300′A, 300′B, 300′C, 300D′. For example, the leg pivot bar 510 and the latch pivot bar 520 of the locking mechanisms 500′A may extend between two adjoining horizontal bars 300′A and 300′B diagonally with respect to the horizontal bars 300′A and 300′B.

FIG. 10B shows a bottom view of another foldable table 100″ constructed according to the principles of the disclosure. A main panel 200″ of the foldable table 100″ may have a substantially elliptical shape. Also, the main panel 200″ may have six legs 400″A, 400″B, 400″C, 400″D, 400″E, 400″F. The foldable table 100″ may not be configured with the side panels 300 (shown in FIGS. 1 and 2) or the horizontal bars 300′ (shown in FIG. 10A). Instead, the foldable table 100″ may includes a plurality of pivot blocks 305A, 305B, 305C, 305D, 305E, 305F to accommodate folding and locking mechanisms 500″A, 500″B, 500″C, 500″D, 500″E, respectively, and the legs 400″A, 400″B, 400″C, 400″D, 400″E, 400″F, respectively.

Each of the pivot blocks 305A, 305B, 305C, 305D, 305E, 305F may be formed by connecting two or more pivot block members. For example, the pivot block 305A may be formed by adjoining two pivot block members 310A, 312A perpendicularly. A leg pivot bar 510″A and a latch pivot bar 520″A of the folding and locking mechanisms 500″A may extend between the pivot block members 310A, 312A diagonally with respect thereto. More than two pivot block members may be used to form a pivot block member. For example, the pivot block 305B may be formed by adjoining three pivot block members 310B, 312B, 314B in a “U” shape as shown. A leg pivot bar 510″B and a latch pivot bar 520″B of the folding and locking mechanisms 500″B may extend between the pivot block members 310B, 312B substantially parallel to the pivot block members 314B.

According to the embodiments of the disclosure, the folding and locking mechanism for a table may be completely hidden under the main panel of the table such that it may not be easy to inadvertently unlock the legs. This may prevent the legs from being accidentally unfolded by those who are not familiar with the folding mechanism, such as, e.g., children. Thus, the table may be much safer to use in any permanent or temporarily situations. Also, the table may be visually more attractive since the folding mechanism may not be exposed externally. Furthermore, the table may be less trouble-prone and more reliable than the conventional folding tables due to the folding and locking mechanism.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A table comprising:
a main panel;
a plurality of side panels extending along a plurality of edges of the main panel, respectively, and comprising first and second side panels connected to each other at a corner of the main panel;
a first pivot bar extending between inner surfaces of the first and second side panels near the corner of the main panel;
a leg connected to the first pivot bar and configured to pivotally move between an unfolded position and a folded position with respect to the first pivot bar; and
a locking unit configured to selectively engage the leg to prevent the leg from departing from the unfolded position.

2. The table of claim 1, wherein the main panel and the first and second side panels cover the first pivot bar and the locking unit to prevent the first pivot bar and the locking unit from being seen by a by-stander.

3. The table of claim 1, wherein the first and second side panels are configured to prevent the leg from pivotally moving outwardly from the unfolded position.

4. The table of claim 1, wherein the leg comprises:
an opening formed at the upper end portion of the leg and extending from an outer surface to an inner surface of the leg; and
a locking bar located on the inner surface of the leg adjacent to a bottom end of the opening.

5. The table of claim 4, wherein the locking unit comprises:
a second pivot bar extending between inner surfaces of the first and second side panels near the corner of the main panel;
a latch pivotally connected to the second pivot bar and extending through the opening of the leg to selectively engage the locking bar to prevent the leg from pivotally moving from the unfolded position; and
a spring connected to the latch to bias the latch towards the locking bar of the leg.

6. The table of claim 4, wherein the second pivot bar is located between the first pivot bar and the corner of the table.

7. The table of claim 5, wherein the spring is extending from the first pivot bar to the latch via the opening of the leg.

8. The table of claim 5, wherein the latch comprises:
a first end portion pivotally connected to the second pivot bar and connected to the spring;
a body portion extending through the opening of the leg and comprising a first cutout configured to engage the locking bar of the leg;
a second end comprising a lever protruding inwardly from the inner surface of the leg,
wherein the first cutout portion is disengaged from the locking bar of the leg when a force is applied to move the lever upwardly.

9. The table of claim 8, wherein the body portion of the latch further comprises a second cutout to prevent the latch from contacting the first pivot bar when the leg is in the folded position.

10. The table of claim 8, wherein the body portion of the latch is bent upwardly near the lever.

11. A folding mechanism for a foldable table, comprising:
a pivot block connected to a main panel of the foldable table;
a first pivot bar connected to the pivot block and a leg of the foldable table to allow the leg to pivotally move between an unfolded position and a folded position;
a second pivot bar connected to the pivot block; and
a latch pivotally connected to the second pivot bar and configured to selectively engage the leg to lock the leg in the unfolded position.

12. The folding mechanism of claim 11, wherein the pivot block is located on a bottom surface of the main panel.

13. The folding mechanism of claim 11, wherein the pivot block is configured to prevent the leg from pivotally moving outwardly from the unfolded position.

14. The folding mechanism of claim 11, wherein the leg of the foldable table comprises:
an opening formed at the upper end portion of the leg and extending from an outer surface to an inner surface of the leg; and
a locking bar located on the inner surface of the leg adjacent to a bottom end of the opening.

15. The folding mechanism of claim 14, wherein the latch extends through the opening of the leg to selectively engage the locking bar of the leg.

16. The folding mechanism of claim 14, further comprising a spring connected to the latch to urge the latch toward the locking bar of the leg.

17. The folding mechanism of claim 16, wherein the spring is extending from the first pivot bar to the latch via the opening of the leg.

18. The folding mechanism of claim 16, wherein the latch comprises:
a first end portion pivotally connected to the second pivot bar and connected to the spring;
a body portion extending through the opening of the leg and comprising a first cutout configured to engage the locking bar of the leg;
a second end comprising a lever protruding inwardly from the inner surface of the leg,
wherein the first cutout portion is disengaged from the locking bar of the leg when a force is applied to move the lever upwardly.

19. The folding mechanism of claim 18, wherein the body portion of the latch further comprises a second cutout to prevent the latch from contacting the first pivot bar when the leg is in the folded position.

20. The folding mechanism of claim 18, wherein the body portion of the latch is bent upwardly near the lever.
